(19) United States
(12) Patent Application Publication
(10) Pub. No.: US 2026/0172902 A1
(43) Pub. Date: Jun. 18, 2026

(54) CELLULAR NETWORK SLICE SECURITY

(71) Applicant: AT&T Intellectual Property I, L.P., Atlanta, GA (US)

(72) Inventors: Joseph Soryal, Glendale, NY (US); Venson Shaw, Kirkland, WA (US)

(21) Appl. No.: 18/979,562

(22) Filed: Dec. 12, 2024

(51) Int. Cl. H04W 28/08; H04W 24/08

(52) U.S. Cl. CPC H04W 28/0958; H04W 24/08

(57) ABSTRACT

A processing system including a processor may obtain, from a communication network, a network slicing token, the network slicing token comprising a configuration code to cause the processing system to perform a data traffic monitoring function, the data traffic monitoring function including collecting one or more performance indicators associated with data traffic communications via a network slice and transmitting the one or more performance indicators to the communication network. The processing system may next commence data traffic communications with a counterparty communication system via the network slice of the communication network in accordance with the network slicing token. The processing system may then collect the one or more performance indicators associated with the data traffic communications via the network slice of the communication network in accordance with the configuration code and may further transmit the one or more performance indicators associated with the data traffic communications to the communication network.

The present disclosure relates generally to cellular communication networks, and more particularly to methods, non-transitory computer-readable media, and apparatuses for commencing data traffic communications by a processing system with a counterparty communication system via a network slice of a communication network in accordance with a network slicing token that includes a configuration code to cause the processing system to perform a data traffic monitoring function, and to methods, non-transitory computer-readable media, and apparatuses for detecting at least one anomaly from one or more performance indicators associated with data traffic communications via a network slice obtained from a first communication system participating in a communication session via the network slice in accordance with a network slicing token.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Ultimately, 5G may deliver superior high speed and performance.

### SUMMARY

In one example, the present disclosure discloses a method, computer-readable medium, and apparatus for commencing data traffic communications by a processing system with a counterparty communication system via a network slice of a communication network in accordance with a network slicing token that includes a configuration code to cause the processing system to perform a data traffic monitoring function. For example, a processing system including at least one processor may obtain, from a communication network, a network slicing token, the network slicing token comprising a configuration code to cause the processing system to perform a data traffic monitoring function, the data traffic monitoring function including collecting one or more performance indicators associated with data traffic communications via a network slice and transmitting the one or more performance indicators to the communication network. The processing system may next commence data traffic communications with a counterparty communication system via the network slice of the communication network in accordance with the network slicing token. The processing system may then collect the one or more performance indicators associated with the data traffic communications via the network slice of the communication network and may further transmit the one or more performance indicators associated with the data traffic communications to the communication network in accordance with the configuration code.

In one example, the present disclosure also discloses a method, computer-readable medium, and apparatus for detecting at least one anomaly from one or more performance indicators associated with data traffic communications via a network slice obtained from a first communication system participating in a communication session via the network slice in accordance with a network slicing token. For example, a processing system including at least one processor when deployed in a communication network may obtain from a first communication system participating in a communication session with a second communication system via a network slice of the communication network, one or more performance indicators associated with data traffic communications via the network slice of the communication network. The one or more performance indicators may be obtained in accordance with a network slicing token, where the network slicing token comprises a configuration code to cause the first communication system to perform a data traffic monitoring function. The data traffic monitoring function may include collecting the one or more performance indicators associated with data traffic communications via the network slice and transmitting the one or more performance indicators to the communication network. The processing system may further detect at least one anomaly from the one or more performance indicators associated with data traffic communications via the network slice and perform at least one remedial action with respect to the network slice in response to the detecting of the anomaly from the one or more performance indicators.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for commencing data traffic communications by a processing system with a counterparty communication system via a network slice of a communication network in accordance with a network slicing token that includes a configuration code to cause the processing system to perform a data traffic monitoring function;

FIG. 3 illustrates a flowchart of an example method for detecting at least one anomaly from one or more performance indicators associated with data traffic communications via a network slice obtained from a first communication system participating in a communication session via the network slice in accordance with a network slicing token; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for commencing data traffic communications by a processing system with a counterparty communication system via a network slice of a communication network in accordance with a network slicing token that includes a configuration code to cause the processing system to perform a data traffic monitoring function, and methods, computer-readable media, and apparatuses for detecting at least one anomaly from one or more performance indicators associated with data traffic communications via a network slice obtained from a first communication system participating in a communication session via the network slice in accordance with a network slicing token. In particular, in 5G and upcoming 6G networks, network slicing is one of the defining features relating to quality of service (QoS) parameters and user experience measures. For example, a cellular network may utilize network slicing, e.g., as described/defined in 3GPP technical standard (TS) 23.501, and may therefore be comprised of many slices, each with different characteristics. In addition, such a cellular network may include a slice orchestrator, such as described in 3GPP TS 28.530 and/or 28.531.

Examples of the present disclosure anticipate that malicious distributed applications (clients) and/or compromised servers may maliciously request network slices that are not for legitimate application usage. Instead, network slice resources may be tied up for a slice having little to no data traffic and/or conveying malicious data traffic, which may result in denial of requests for additional slices and/or unavailability of network resources for other slices to convey legitimate data traffic. Accordingly, examples of the present disclosure help ensure that each network slice is created for legitimate communications between non-malicious entities, and for a non-malicious application, or applications.

To further illustrate, a user having a cellular endpoint device, or user equipment (UE), may engage in a communication session with a network-based server, such as an online banking server, a server of a medical or educational institution, a server of a governmental entity, a gaming server, a streaming video server, and so forth. In accordance with the present disclosure, the cellular endpoint device or server may request a dedicated network slice across the communication network to serve the communication session (e.g., including across the radio access network (RAN), cellular core network, and/or a transport network portion of the communication network, etc.). In this regard, it should be noted that at present, cellular endpoint devices may support up to eight slices, and may group applications together for slice access/utilization. For instance, network slices may generally be pre-configured for groups of applications and/or classes of endpoint devices (e.g., first responder devices versus cellular endpoint devices of the general population, or the like). However, in accordance with the present disclosure, each application (or certain selected applications) may have the ability to request one or more network slices with certain resource allocations, e.g., QoS and/or service level agreement (SLA) thresholds, security controls, etc. For instance, the present disclosure may include examples relating to slicing on demand, e.g., via pressing a button on a cellular endpoint device, or via pre-configuration of the cellular endpoint device (e.g., every time a banking application is opened, request a dedicated slice). In some examples, servers may also initiate slice requests. For instance, a user may interact with a hospital website via a web-server. However, if the interaction advances to where the user may request medical records or other protected patient information, the hospital server may initiate a request for a dedicated slice, e.g., for added security.

In one example, a slice orchestrator (SO) may create unique network slicing tokens (NSTs) (which may also be referred to as intelligent slicing tokens (IST)) for use in instantiating and or accessing network slices. In one example, NSTs may be limited in number and limited in active time where an associated network slice is available. The slice orchestrator may provide some of these NSTs to authenticated legitimate servers based on a server request, e.g., when a communication session is initiated between a server and a client. One or more of such NSTs may also be granted to authenticated clients (e.g., one token per client, one token per application, and/or one token per communication session). In one example, when the application on the client (e.g., a cellular endpoint device) is active and when network slice construction is warranted, either party to the communication session (client or server depending which is initiating the network slice instantiation) may request a NST from the slice orchestrator. If the slice orchestrator authenticates the requester, then a NST may be granted. The slice orchestrator may then proceed to reserve network resources and to create the network along the route (e.g., RAN, cellular core, and/or transport network, etc.). In one example, the NST that was granted to the requester (either client or server-side) may self-replicate once and send the other copy to the counterparty computing system. Accordingly, both the client and the server may have a copy of the NST.

In particular, in one example, an NST may comprise configuration code, e.g., an executable package and/or file, which may cause the NST to self-replicate. In one example, each NST may be duplicated only once. To further illustrate, in an example in which the client initiates the network slice, the client may execute the NST to generate the replica NST and to transmit the replica NST to the server. In one example, the configuration code may further cause/configure the client to perform a data traffic monitoring function associated with the network slice and/or the data traffic thereof. For example, the client may track inbound and/or outbound data utilization in terms of bits and/or bytes, a number of data packets, etc. (broadly a data volume). Alternatively, or in addition, the client may track other performance indicators, such as average packet size, packet inter-arrival time, average burst duration, and so forth (and similarly for the server, which may execute configuration code in accordance with the replica NST). The configuration code may further cause the client (and similarly the server) to report such performance indicator(s) to the slice orchestrator and/or to another network function, such as a data repository function (e.g., a database system). In one example, the client may append at least a fragment of the NST (e.g., a hashed NST identifier, or the like) so that the communication network (e.g., the slice orchestrator and/or other NF) may attribute the performance indicator(s) to the correct network slice. In one example, the client may also append a hashed NST identifier to the outbound data traffic for further verification within the network (e.g., at the NFs along the network slice). In one example, the NST may include an Internet Protocol (IP) address or the like, which may identify the slice orchestrator and/or other NF(s) to which the collected performance indicator(s) should be transmitted.

In one example, the NST may be extracted and converted to a flat file (e.g., an executable file or package that does not rely upon any outside function calls, procedures, libraries, etc.). In one example, the NST may include a unique hash and the IP address to forward the observed traffic patterns or other network performance indicators. In one example, the extracted NST may be instantiated as a container or virtual machine (VM) to perform the functions described herein. In one example, the VM/container may have access to an input/output interface (e.g., via an application programming interface (API) or the like of the application using the network slice) and/or to a transmission control protocol (TCP)/IP stack of the client device and/or the server to perform the data traffic monitoring functions and to transmit the replica NST. The replicated NST may travel along the network slice that was just created. When instantiated on the server, the two NSTs may then communicate via the network slice, e.g., to the slice orchestrator or other NFs, and/or with each other. In one example, the two NSTs may bring about the monitoring of the traffic patterns across the network slice (without decoding or decrypting the traffic to keep the session private). In addition, the two NSTs, independently, may report to the communication network regarding the traffic patterns, e.g., one or more performance indicators associated with data traffic communications via the network slice.

In one example, the slice orchestrator or other NFs may analyze the network performance indicators (e.g., the traffic patterns and/or characteristics thereof) from one or both ends of the communication session via the network slice to ensure that the network slice is being used. For instance, instantiating the network slice without data traffic may be indicative of a denial of service (DoS attack) tying up network resources in the network slice that are now unavailable for other uses. In one example, the slice orchestrator or other NFs may also ensure that components of the network slice along the way do not alter the data traffic or act as a blackhole, e.g., by confirming that the data traffic sent by one participating entity is received in the same form by the other participating entity in accordance with the respective performance indicators collected from the respective ends.

In one example, the slice orchestrator or other NFs may also compare the usage of the current network slice to historic or current usage and traffic patterns for other clients to the same server or similar servers, e.g., via one or more other network slices. For instance, a deviation in utilization of the subject network slice as compared to similar network slices may indicate that client and/or the server is just holding slice resources without actually utilizing them fully, e.g., sending dummy traffic so as to not appear completely idle. Likewise, in one example, the slice orchestrator or other NFs may compare the traffic patterns and data volume across the subject network slice to slice-dedicated resources to ensure there is no resource over-commitment issues, which may be malicious or which may be the result of a misconfiguration of the application, operator error, etc.

In one example, at the completion of a communication session and/or at the expiration of the NST(s), the NST(s) may be discarded. If there is a need for a new communication session and/or a resumption of an uncompleted session, a new NST and replica may be created with new unique code and disseminated to the client and/or to the server. In one example, an excessive number or frequency of NST requests from a single entity compared to other similar entities (e.g., clients/UEs and/or servers) may also indicate a potential malicious activity or other anomalies, such as a distributed denial of service (DDoS) attack seeking to unnecessarily instantiate a number of network slices. In one example, a NST may include an additional module comprising a configuration code which may cause the host devices (e.g., client or server) to execute a light antivirus program to further ensure that there are no malware triggered slicing requests.

In one example, the slice orchestrator may include a provisioning module, which interacts with the cellular network (e.g., the NFs and/or network elements, host devices, etc.) to provision, instantiate, and/or deploy network slices, and an inventory module which tracks and reports on slices that are currently in operation. For instance, the slice orchestrator may be configured to observe the real-time health of the network (including the slices thereof) and endpoint performance, such as measurements of network and slice-specific performance and health. To further illustrate, this may include monitoring of various network performance indicators, e.g., “key performance indicators” (KPIs), such as control indicator logs, e.g., “key control indicator” (KCI) logs, alarms/alerts, and so forth. In one example, the slice orchestrator may further include an artificial intelligence (AI)/machine learning (ML)-based module that may obtain, inspect, and analyze user plane data traffic (e.g., packets, frames, datagrams, etc.) for anomalies. In one example, the inventory module may generate and maintain a network model based on real-time/current and historic topology and observations. In one example, the AI/ML-based module, or AI/ML module, may include a rules engine with pre-provisioned instructions on how to handle security anomalies. In one example, users/subscribers may opt-in to the additional slice-based network security services in accordance with the present disclosure.

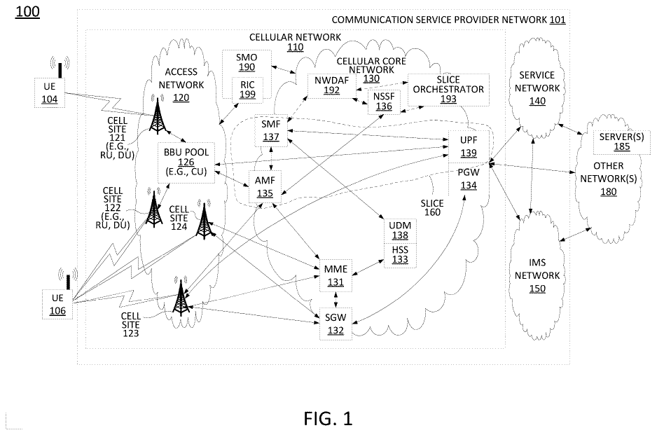

In accordance with the present disclosure, malicious activities or other anomalies may be indicated by high rate of retransmissions, low rate of observed throughput, atypical traffic patterns based on historical trend, etc. In one example, the slice orchestrator or other NFs may perform one or more remedial actions in response to an anomaly detection. For instance, the subject network slice may be expanded to include a specific routing to one or more network security network functions (NFs), such as a deep packet inspection (DPI) system/tool to look more closely at the traffic, a scrubber to filter malicious traffic, a walled garden to quarantine traffic for either or both participating entities (e.g., client and/or server) until an attack is over and/or endpoint device(s) is/are patched, and so forth. In another example, the current network slice may be discarded. In one example, a new network slice may be instantiated, e.g., with a new NST, and so forth. In one example, a new network slice may be created with different characteristics in an attempt to provide better performance. After continued observation, the cellular network may determine if network conditions are the same, better, or worse. If network conditions are not better, the cellular network can iteratively attempt to change new network slice characteristics using trial and error, e.g., reinforcement learning (RL), or the like, until an optimal and/or satisfactory set of characteristics is found. The final step could involve updating the original slice with the optimal characteristics and de-instantiating the new slice, or de-instantiating the original slice to continue with the new slice. These and other aspects of the present disclosure are discussed in greater detail below in connection with the examples of FIGS. 1-4.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and or O-RAN infrastructure may include radio units (RUs)/RRHs, distributed units (DUs), and centralized units (CU) (e.g., where baseband units (BBUs) may include CUs and/or CUs in conjunction with DUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas. In accordance with the present disclosure, a base station may comprise one of cell sites 121-123. Alternatively, or in addition, a base station may comprise one of baseband units within BBU pool 126 or a portion thereof (e.g., a CU, a DU, or a CU in conjunction with a DU), or a BBU of BBU pool 126 in conjunction with an RU or RRH of one of cell sites 121-123.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126. In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-124. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and any future generation of wireless cellular technology, e.g., 6G the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, a network data analytics function (NWDAF) 192, and a slice orchestrator (SO) 193.

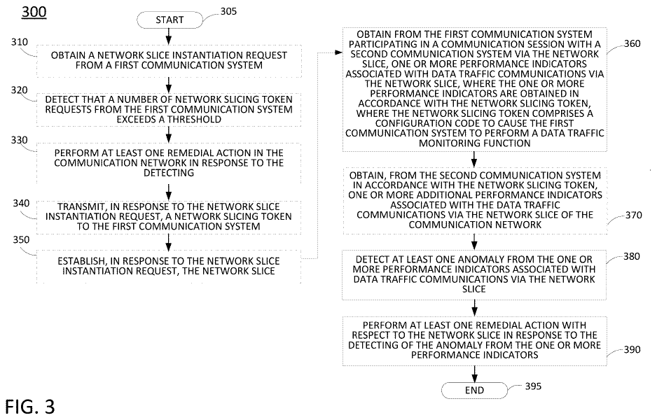

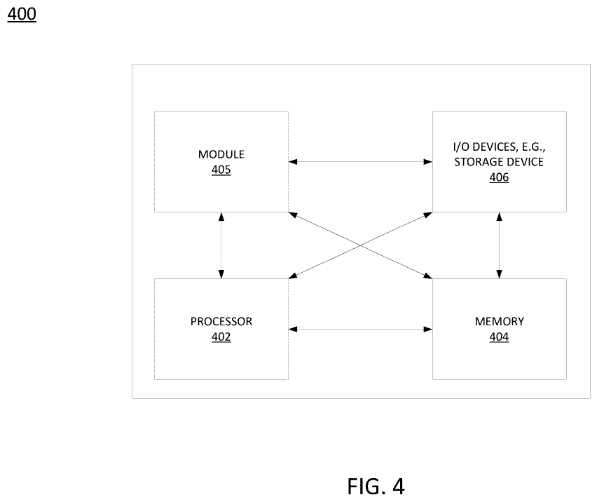

In one example, slice orchestrator 193 and/or NWDAF 192 may each comprise all or a portion of a computing device or system, such as computing system 400, and/or processing system 402 as described in connection with FIG. 4 below, and may be configured to perform various operations in connection with examples of the present disclosure for detecting at least one anomaly from one or more performance indicators associated with data traffic communications via a network slice obtained from a first communication system participating in a communication session via the network slice in accordance with a network slicing token (e.g., as illustrated and described in connection with the example of FIG. 3). In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth. As noted above, in accordance with the present disclosure, network slices may also be requested and instantiated on an individualized basis, e.g., a dedicated network slice for an enterprise (e.g., one or more servers hosting client facing services and/or for virtual private network (VPN) support via dedicated network slice(s), etc.) and/or for individuals (e.g., UEs that may seek to communicate with remote counterparties, which may include other UEs, enterprise servers, etc.). In one example, NSSF 136 may communicate with AMF 135 to provide the authorization for a UE to access a particular network slice, such as a dedicated/individualized network slice as described herein.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

In one example, cellular network 110 may comprise a “non-stand alone” (NSA) mode architecture, where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, in another example, the present disclosure may relate to a hybrid, or integrated 4G/LTE-5G cellular core network, such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure. As illustrated in FIG. 1, other networks 180 may include one or more servers 185. For example, server(s) 185 may participate in communication sessions with client devices, such as user equipment (UE) 104 and 106 via one or more dedicated network slices (e.g., individualized network slices) as described herein.

FIG. 1 also illustrates various mobile/cellular endpoint devices, e.g., user equipment (UE) 104 and 106. UE 104 and 106 may each comprise a cellular telephone, a smartphone, a tablet computing device, a laptop computer, a pair of computing glasses, a pair of wireless goggles, a wireless enabled wristwatch, a wireless transceiver for a fixed wireless broadband (FWB) deployment, or any other cellular-capable mobile telephony and computing devices (broadly, “a mobile endpoint device” or “cellular endpoint device”). In one example, each of the UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of the UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

As illustrated in FIG. 1, UEs 104 and 106 may register and attach to any of cell sites 121-124 to obtain network services from cellular network 110 and/or communication service provider network 101. This may include detecting a primary synchronization signal (PSS), secondary synchronization signal (SSS), physical broadcast channel (PBCH), and/or demodulation reference signal (DMRS), engaging a random access channel to report to the selected cell site and establish a radio resource control (RRC) communication, transmitting a registration/attach request, performing authentication procedures, establishing a default protocol data unit (PDU) session, e.g., including bearer assignment, and so forth.

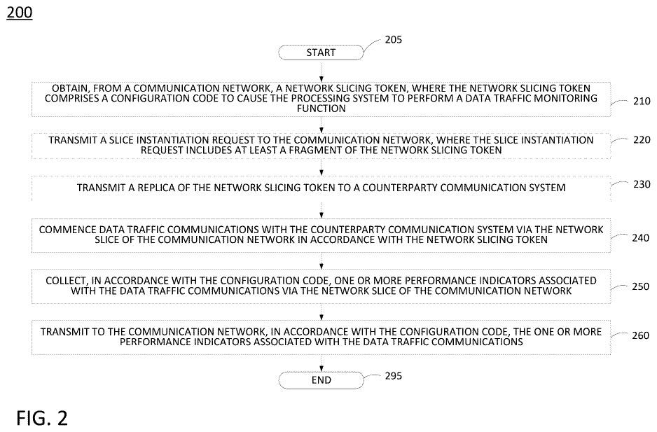

In one example, UEs 104 and 106, and/or server(s) 185 may each comprise all or a portion of a computing device or system, such as computing system 400, and/or processing system 402 as described in connection with FIG. 4 below, and may be configured to perform various operations in connection with examples of the present disclosure for commencing data traffic communications by a processing system with a counterparty communication system via a network slice of a communication network in accordance with a network slicing token that includes a configuration code to cause the processing system to perform a data traffic monitoring function (e.g., as illustrated and described in connection with the example of FIG. 2).

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node, such as a virtual AMF (vAMF), a virtual SMF (vSMF), a virtual UPF (vUPF), etc. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 192, and/or UPF 139, and other components of system 100 are also omitted for clarity, such as additional routers, switches, gateways, and the like.

In one example, SMO 190 may include a RAN intelligent controller (RAN-IC or RIC) 199. For instance, in an O-RAN architecture, the RIC 199 may be deployed for managing and controlling various RAN components/functions, e.g., CUs, DUs, and RUs. For instance, RIC 199 may comprise a platform that hosts various RAN applications (e.g., xApps/rApps) that may be used to configure and reconfigure various components of access network 120. In one example, aspects of RIC 199 may represent functionality of an SON orchestrator, or vice versa.

In an illustrative example, UE 104 may establish a communication session or may seek to establish a communication session with one of the server(s) 185. However, in one example, UE 104 may first initiate a communication to slice orchestrator 193 to request and to obtain a network slicing token (NST). In one example, slice orchestrator 193 may authenticate UE 104 and/or a user thereof, e.g., based on the international mobile equipment identity (IMEI) or the like, based on a user entry of a password via UE 104 that is conveyed to slice orchestrator 193 in connection with the request, etc. In one example, the request may include preferred network slice characteristics/parameters (e.g., minimum guaranteed bandwidth, throughput, latency, additional security features (such geographic restrictions of VNFs allocated to the slice, etc.), and so forth. Alternatively, or in addition, the request may indicate the intended counterparty to the communication session (e.g., the one of server(s) 185). For example, server(s) 185 may represent an online banking system, a healthcare provider system, or the like, where the operating entity may have a preexisting arrangement with the communication service provider network 101 for the use of dedicated network slices for client communication sessions, e.g., with a particular service level agreement (SLA) having target performance indicator metrics (e.g., minimum bandwidth and/or minimum throughput, maximum latency, etc.).

In any case, slice orchestrator 193 may verify UE 104 and/or the user thereof. For instance, this may include slice orchestrator 193 referring to UDM 138 or the like to extract a user profile or UE profile to determine that the user and/or UE 104 is entitled to utilize a dedicated slice. In one example, the data in UDM 138 may further indicate a SLA, which may include network slice characteristics/parameters to which the user and/or UE 104 may be entitled (or alternatively, to which the server(s) 185 may be entitled to offer to its clients). When the user/UE 104 is authorized, slice orchestrator 193 may generate and/or transmit a NST to UE 104. The slice orchestrator 193 may then proceed to reserve network resources and to create the network slice along the route (e.g., RAN, cellular core, and/or transport network, etc.). For instance, slice orchestrator 193 may arrange a slice 160 (e.g., a network slice, or “slice instance,” comprising AMF 135, SMF 137, UPF 139, etc.). In one example, any one or more of these NFs may comprise a VNF. In one example, slice orchestrator 193 may work in conjunction with other NFs to ensure the provisioning of slice 160, such as SMO 190. For instance, SMO 190 may instantiate VNFs as an AMF 135, SMF 137, UPF 139, etc., while slice orchestrator 193 may configure the VNFs to operate as an integrated slice. In one example, the network slice 160 may further include RAN resources (e.g., a CU, a DU, and/or an RU, or the like, e.g., represented by BBU pool 126 and/or one of cell sites 121-123), transport network resources, e.g., between access network 120 and cellular core network 130, and so forth. In one example, slice orchestrator 193 may provide to NSSF 136 information about the slice 160, as well as the entities authorized to use the slice 160 and/or information about the NST.

Concurrently, UE 104 may initiate a PDN session by initiating a request to AMF 135. In one example, AMF 135 may query NSSF 136 for one or more network slices in response to the request. The NSSF 136 may provide the selection to AMF 135, or may provide one or more permitted network slices to AMF 135, where AMF 135 may select the network slice from among the choices. In one example, UE 104 may include the NST or a fragment thereof (e.g., a NST identifier) in the request. Accordingly, the AMF 135 may include the identifier in the query to the NSSF 136. Continuing with the present example, NSSF 136 and/or AMF 135 may select to assign the PDN session to slice 160 (e.g., which may include AMF 135 itself, but in another example, which could include a different AMF). In still another example, the UE 104 may initiate a PDN session by initiating a request to AMF 135, where the request may include a dedicated slice allocation request. For instance, AMF 135 may pass the request to NSSF 136, which may in turn submit the request to slice orchestrator 193 for approval. Upon approval, slice orchestrator 193 may cause slice 160 to be generated (if slice orchestrator 193 chooses not to utilize an existing slice that may be repurposed) and may pass a NST to NSSF 136. In turn, NSSF 136 may forward the NST to UE 104 via AMF 135. In other words, UE 104 may request the PDN session and dedicated slice in a single request, and may receive the NST in response, rather than initiating a separate request for the NST prior to requesting PDN session establishment.

The UE 104 may receive the NST and un-package the NST, e.g., extracting configuration code and running the configuration code as an executable package/application. For instance, the NST may first cause UE 104 to self-replicate the NST and to transmit the NST replica to the one of the server(s) 185 that UE 104 is or will be communicating with. The replicated NST may travel along the network slice 160. Accordingly, both the client, UE 104, and the one of the server(s) 185 may have a copy of the NST. When instantiated on the one of server(s) 185, the two NSTs may then communicate via the network slice 160, e.g., to the slice orchestrator 193 or other NFs, and/or with each other. For instance, as noted above the NST may be extracted and converted to a flat file (e.g., an executable file or package that does not rely upon any outside function calls, procedures, libraries, etc.). In one example, the NST may include a unique hash and the IP address to forward the observed traffic patterns or other network performance indicators (e.g., an IP address identifying slice orchestrator 193 or other NFs, such as NWDAF 192). In one example, the extracted NST may be instantiated as a container or virtual machine (VM) to perform the functions described herein. In one example, the VM/container may have access to an input/output interface (e.g., via an application programming interface (API) or the like of the application using the network slice 160) and/or to a transmission control protocol (TCP)/IP stack of the UE 104 (or of the one of the server(s) 185).

In one example, UE 104 and the one of the server(s) 185 may begin communicating via the slice 160 (e.g., transmitting and/or receiving data packets). In one example, either or both of the communicating entities may append a hashed NST identifier, e.g., a fragment of the NST, or the like, to the outbound data traffic for further verification within the communication service provider network 101 (e.g., at the NFs along the network slice). For instance, when provisioning the slice 160, slice orchestrator 193 may provide the NST identifier (e.g., a hashed version of the NST identifier) to the slice elements, such as UPF 139, which may then be prepared to allow or block the data traffic, e.g., depending on whether a packet header includes the correct NST identifier.

As noted above, the configuration code may further cause participating entities to perform a data traffic monitoring function associated with the network slice 160 and/or the data traffic thereof. For example, the configuration code may cause the UE 104 and the one of the server(s) 185 to track respective inbound and/or outbound data utilization in terms of bits and/or bytes, a number of data packets, etc. (broadly a data volume). In accordance with the configuration code, UE 104 and the one of the server(s) 185 may alternatively or additionally track other performance indicators, such as average packet size, packet inter-arrival time, average burst duration, and so forth. The configuration code may further cause UE 104 and the one of the server(s) 185 to report such performance indicator(s) to the slice orchestrator 193 and/or to another network function, such as NWDAF 192. In one example, UE 104 and the one of the server(s) 185 may append a hashed NST identifier, e.g., a fragment of the NST, or the like so that the communication service provider network 101 (e.g., the slice orchestrator 193 and/or other NFs) may attribute the performance indicator(s) to the correct network slice 160. For instance, as noted above, the NST may include an Internet Protocol (IP) address or the like, which may identify the slice orchestrator 193 and/or other NF(s), such as NWDAF 192, to which the collected performance indicator(s) should be transmitted.

In one example, the slice orchestrator 193 may analyze the network performance indicators (e.g., the traffic patterns and/or characteristics thereof) from one or both ends of the communication session via the network slice 160 to detect and address anomalies, e.g., malicious activities or other activities that may be detrimental to the communication service provider network 101. For instance, slice orchestrator 193 may ensure that the slice 160 is being used (e.g., instantiating the network slice without data traffic may be indicative of a denial of service (DoS attack)). In one example, the slice orchestrator 193 may also ensure that components of the network slice along the way do not alter the data traffic or act as a blackhole, e.g., by confirming that the data traffic sent by UE 104 is received in the same form by the one of the server(s) 185 in accordance with the respective performance indicators collected from the respective ends (and vice versa). In one example, the slice orchestrator 193 may also compare the usage of the current network slice 160 to historic or current usage and traffic patterns for other clients to the same server or similar servers, e.g., via one or more other network slices. For instance, a deviation in utilization of the subject network slice 160 as compared to similar slices may indicate that UE 104 and/or the one of the server(s) 185 is just holding slicing resources without actually utilizing them fully. Likewise, in one example, the slice orchestrator 193 may compare the traffic patterns and data volume across the subject network slice 160 to slice dedicated resources to ensure there is no resource overcommitting issues, which may be malicious or which may be the result of a misconfiguration of an application on UE 104, a misconfiguration of the one of the server(s) 185, etc.

In one example, slice orchestrator 193 may detect one or more types of anomalies in accordance with a rule set, e.g., with one or more thresholds for one or more performance indicators that may indicate an anomaly. For instance, when a volume of data traffic on slice 160 is below a first threshold, this may indicate a denial of service attack using the dedicated slice 160. Alternatively, or in addition, when data traffic on slice 160 is below a first threshold percentage of an allocated throughput availability, this may indicate a denial of service attack using the dedicated slice 160. For instance, instead of a threshold in absolute terms, one or more rules may specify a threshold that is a percentage of a capability of slice 160 according to a slice provisioning. Still other rules may be based upon moving averages, weighted moving averages, or the like with respect to one or more performance indicators. For instance, a deviation in a data volume on slice 160 as compared to similar slices associated with client interactions with the one of the server(s) 185 in the past week, or the like. Alternatively, or in addition, one or more rules may define that an anomaly exists in accordance with a formula based on two or more performance indicators.

Alternatively, or in addition, slice orchestrator 193 may implement one or more machine learning models (MLMs) that are configured to detect slice utilization anomalies based upon performance data collected from participating entities in a communication session using a given slice. For instance, such a MLM may generate an output indicating whether an anomaly exists, or whether a particular type of anomaly exists (such as a DoS attack), e.g., in response to an input vector comprising the performance data from one or both of the UE 104 and the one of the server(s) 185. In one example, the input vector may further include performance data from other network slices (e.g., slices that may be geographically related, slices that may have NFs (e.g., VNFs) existing on overlapping or partially overlapping sets of host devices/NFVI, slices that may be for the same server but with a different client and/or for a different but similar server, and so forth). Alternatively, or in addition, a MLM may be particularized, e.g., trained to predict/detect anomalies with respect to a particular slice type, with respect to slices for a particular entity or type of entity (such as a banking institution, a medical service provider, etc.), or the like. Thus, for example, such a MLM may be retrained periodically or otherwise with additional training data comprising performance data from other network slices (e.g., slices that may be geographically related, slices that may have NFs (e.g., VNFs) existing on overlapping or partially overlapping sets of host devices/NFVI, slices that may be for the same server but with a different client and/or for a different but similar server, and so forth).

In this regard, it should be noted that in one example, slice orchestrator 193 may implement one or more machine learning algorithms (MLAs), e.g., one or more trained machine learning models (MLMs) for slice anomaly detection and/or for other tasks in accordance with the present disclosure. For instance, the MLA (or the trained MLM) may comprise a deep learning neural network, or deep neural network (DNN), such as convolutional neural network (CNN), a generative adversarial network (GAN), a language model, or “large language model” (LLM) such as a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In the case of the use of a language model for slice anomaly detection, network performance data may be converted to text form, where the language model may vectorize the text, e.g., via word2vec, doc2vec, or the like, for processing via a LLM core, for instance. In still other examples, slice orchestrator 193 may implement one or more anomaly detection MLMs comprising a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on.

In one example, for forecasting/prediction tasks, the present disclosure may train and apply one or more time series prediction/forecasting models (e.g., AI/ML models) based upon historical network performance information of a particular network slices, or across a plurality of network slices of a same type, for a same entity, or which are otherwise related. For instance, the time series prediction/forecasting model may comprise a moving average (MA) model, an autoregressive distributed lag (ADL) model, an autoregressive integrated moving average (ARIMA) model, a seasonal ARIMA (SARIMA) model, or the like. Similarly, other regression-based models may be trained and used for such prediction/forecasting, such as logistic regression, polynomial regression, ridge regression, lasso regression, etc. In one example, the present disclosure may predict/forecast using multiple factors as predictors (e.g., covariates, or exogenous factors). For instance, a seasonal auto-regressive integrated moving average with exogenous factors (SARIMAX) model may be used. Alternatively, a vector auto-regression (VAR), or VAR moving average (VARMA) model may be used. Similarly, a vector auto-regression moving-average with exogenous factors/regressors (VARMAX) model may be applied. For instance, an input vector may further include a time of day, a day of the week, an indicator of a holiday, an indicator of a mass gathering event associated with an area of either party to a communication session over a dedicated network slice, etc. To further illustrate, a time series prediction/forecasting model may forecast aspects of utilization of slice 160 based on prior performance metrics of slice 160 and/or one or more other related slices. The, the actual observed performance indicators (e.g., current and/or from a recent look-back time window) for slice 160 may be analyzed. For instance, a deviation in excess of a threshold from the predicted/forecast utilization metrics may indicate an anomaly, where the threshold may be a threshold distance between a vector representing historic data and a vector representing the current/most recent collected performance data. In one example, slice orchestrator 193 may detect anomalies based upon the outputs of one or more rules in a rule set and/or based on the outputs of one or more MLMs. In other words, slice orchestrator 193 may implement an ensemble MLM, a MLM pipeline, etc. for slice anomaly detection.

In one example, the slice orchestrator 193 may perform one or more remedial actions in response to an anomaly detection. For instance, the subject network slice 160 may be expanded to include a specific routing to one or more network security network functions (NFs) (not shown) such as a deep packet inspection (DPI) system/tool to look more closely at the traffic, a scrubber to filter malicious traffic, a walled garden to quarantine traffic for either or both participating entities (e.g., client and/or server) until an attack is over and/or endpoint device(s) is/are patched, and so forth. For instance, in one example, an anomaly detection may cause data packets on slice 160 to be copied and forwarded to NWDAF 192 for enhanced processing, such as DPI, etc. For example, slice orchestrator 193 may transmit an instruction to UPF 139 to copy and forward data packets across slice 160 to the NWDAF 192. In another example, the current network slice 160 may be discarded (e.g., spun-down or de-instantiated/de-provisioned). In one example, slice orchestrator 193 may instantiate a new network slice, e.g., with a new NST, and so forth. In one example, an initial response may be to copy data packets to NWDAF 192, while a subsequent action as part of the response may be to de-instantiate the network slice 160, e.g., in response to NWDAF 192 determining/confirming that the data traffic across network slice 160 is malicious. For instance, NWDAF 192 may apply virus detection signatures/patterns to the data traffic across network slice 160, or the like. In one example, a new network slice may be created with different characteristics in an attempt to provide better performance than network slice 160. In another example, a new network slice may be instantiated with lesser allocated resources (e.g., a reduced minimum guaranteed throughput or other SLA/QoS guarantee). For instance, the reservation of slice 160 and the data traffic thereon may be determined to not be malicious. However, the requesting UE 104 may have over-provisioned resources for slice 160 that are not used, and which could be freed-up for reallocation to other slices and/or to other users, etc. In various examples, the remedial actions available to slice orchestrator 193 may be changed and may be updated from time to time, e.g., as additional capabilities become available, as a network operator may prefer to have a particular remedial action available or to retire a remedial action, and so forth.

The foregoing is just one example of dedicated slice provisioning and monitoring. Thus, it should be appreciated that other, further, and different examples may readily be devised in accordance with the present disclosure. For instance, in another example, one of the server(s) 185 may initiate the creation of slice 160, may receive a NST from slice orchestrator 193, may copy and share the NST with UE 104, and so forth. In one example, this may be in the context of an ongoing PDN session for UE 104 communicating with the one of the server(s) 185, e.g., where a switch/transfer/upgrade to a dedicated slice may be warranted, and/or may be in the context of a new PDN session establishment. Alternatively, or in addition, analysis of network performance data related to slice 160 (and other slices), remedial actions, or other aspects described above with respect to slice orchestrator 193 may be performed at NWDAF 192 (and/or in one example, at SMO 190). For instance, in one example, the configuration code of the NST may cause UE 104 and/or the one of the server(s) 185 to report the network performance data to NWDAF 192. NWDAF 192 may then apply one or more rules of a rule set, one or more MLMs, or the like to the network performance data to detect anomalies. In addition, in such an example, NWDAF 192 may be further configured to select and initiate remedial actions as described above. However, in another example, NWDAF 192 may report anomaly detections to slice orchestrator 193 for slice orchestrator 193 to determine whether a threat level warrants a remedial action and/or to select the type of remedial action, and so forth.

In still another example, RIC 199 and/or SMO 190 may request and/or subscribe to various information that may be obtained and stored by NWDAF 192. Alternatively, or in addition RIC 199 and/or SMO 190 may obtain various information from RAN components or other network elements directly (e.g., without NWDAF 192 as an intermediary). In one example, SMO 190 may subscribe to or otherwise obtain network anomaly alerts, reports, or the like from NWDAF 192. In such case, SMO 190 and/or RIC 199 may then implement one or more rule sets and/or MLMs to determine remedial actions, such as whether and when to instantiate a new network slice, to determine the type of network slice and/or characteristics of the new network slice, etc. Accordingly, SMO 190 and/or RIC 199 may then configure/reconfigure one or more aspects of access network 120, cellular core network 130, and/or one or more network slices deployed over the infrastructure of access network 120 and cellular core network 130, e.g., to implement the new network slice. In one example, SMO 190 and/or RIC 199 may accomplish this directly, e.g., without involvement of slice orchestrator 193. Alternatively, SMO 190 and/or RIC 199 may instruct the slice orchestrator 193 to implement the new network slice, where slice orchestrator 193 may communicate with NFs of access network 120 (e.g., gNBs, etc.) and/or of cellular core network 130 (e.g., AMFs, SMFs, UPFs, etc.) to reallocate resources to accommodate the new network slice. In this regard, RIC 199 and/or SMO 190 may comprise all or a portion of a computing device or system, such as computing system 400, and/or processing system 402 as described in connection with FIG. 4 below, and may be configured to perform various operations in connection with examples of the present disclosure for detecting at least one anomaly from one or more performance indicators associated with data traffic communications via a network slice obtained from a first communication system participating in a communication session via the network slice in accordance with a network slicing token (e.g., as illustrated and described in connection with the example of FIG. 3).

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions. In addition, network elements or functions that are illustrating as being deployed in one portion of the communication service provider network 101 may alternatively or additionally be deployed in another portion of the communication service provider network 101. For example, SMO 190 may be deployed in cellular core network 130, within access network 120, or may comprise a distributed computing platform having hardware components within cellular core network 130 and access network 120. Thus, these and other modifications are all contemplated within the scope of the present disclosure.

FIG. 2 illustrates a flowchart of an example method 200 for commencing data traffic communications by a processing system with a counterparty communication system via a network slice of a communication network in accordance with a network slicing token that includes a configuration code to cause the processing system to perform a data traffic monitoring function, in accordance with the present disclosure. In one example, steps, functions and/or operations of the method 200 may be performed by a device as illustrated in FIG. 1, e.g., a cellular endpoint device, such as UE 104 or UE 106, a server, such as server(s) 185, or the like, or collectively via a plurality devices in FIG. 1, such as UE 104, UE 106, or server(s) 185 in conjunction with a different one of such components and/or any one or more other components in FIG. 1, such as slice orchestrator 193, NWDAF 192, SMO 190, RIC 199, or the like, components of access network 120 (e.g., cell sites 121-124, BBU pool 126, etc.) and/or other components of cellular core network 130 (e.g., NSSF 136, slice infrastructure, e.g., slice 160, AMF 135, SMF 137, UPF 139, etc.), and so forth. In one example, the steps, functions, or operations of method 200 may be performed by a computing device or system 400, and/or a processing system 402 as described in connection with FIG. 4 below. For instance, the computing device 400 may represent at least a portion of a cellular endpoint device or a server in accordance with the present disclosure. For illustrative purposes, the method 200 is described in greater detail below in connection with an example performed by a processing system, such as processing system 402. The method 200 begins in step 205 and proceeds to step 210.

At step 210, the processing system obtains, from a communication network, a network slicing token (NST). The NST may comprise a configuration code to cause the processing system to perform a data traffic monitoring function. For instance, the data traffic monitoring function may include collecting one or more performance indicators associated with data traffic communications via a network slice and transmitting the one or more performance indicators to the communication network. In one example, the configuration code may comprise an executable package (e.g., an executable file, or “flat file,” e.g., that is self-contained and that does not rely upon outside function calls, libraries, etc.). In one example, the configuration code may comprise a virtual machine (VM), a container, or the like.

At optional step 220, the processing system may transmit a slice instantiation request to the communication network. In one example, the slice instantiation request may include at least a fragment of the NST (e.g., an NST identifier and/or a slice identifier, a hashed version of the NST identifier and/or slice identifier, etc.). In one example, the network slice may be established by the communication network in response to the slice instantiation request when the NST (e.g., including the at least the fragment of the network slicing token) is validated. The network slice may comprise a network function resource allocation of an AMF, a SMF, and a UPF. In one example, the network slice may further comprise a network resource allocation of at least one RAN component, e.g., a CU, a DU, and/or a RU, etc. In one example, the network slice may further comprise a network resource allocation of one or more transport network components, e.g., intermediate devices between a RAN and the cellular core network, or the like.

At optional step 230, the processing system may transmit to a counterparty communication system, a replica of the NST, e.g., for use in connection with a communication session between the processing system and the counterparty computing system using the network slice that is instantiated. In one example, the replica of the NST may be transmitted to the counterparty communication system via the network slice, e.g., prior to the exchange of user data traffic. The replica of the NST may cause/configure the counterparty communication system to perform the data traffic monitoring function, similar to the processing system itself executing the configuration code of the NST.

At step 240, the processing system commences data traffic communications with the counterparty communication system via the network slice of the communication network in accordance with the NST. For instance, step 240 may include transmitting one or more data packets to the counterparty communication system over the network slice. In one example, the processing system may append at least a fragment of the NST (e.g., a hashed token identifier of the NST and/or a hashed slice identifier) to the one or more data packets transmitted to the counterparty computing system. In one example, step 240 may alternatively or additionally include receiving one or more data packets from the counterparty communication system over the network slice.

At step 250, the processing system (e.g., executing the configuration code) collects the one or more performance indicators associated with the data traffic communications via the network slice of the communication network. For instance as noted above, the one or more performance indicators may include at least one of: a data traffic volume (e.g., inbound, outbound, and/or both individually or combined) or a data traffic pattern (e.g., packet rate, average packet size, packet inter-arrival time, average burst duration, average burst size, and so forth).

At step 260, the processing system (e.g., executing the configuration code) transmits, to the communication network, the one or more performance indicators associated with the data traffic communications.

Following step 260, the method 200 proceeds to step 295 where the method 200 ends.

It should be noted that the method 200 may be expanded to include additional steps or may be modified to include additional operations with respect to the steps outlined above. For example, various steps of the method 200 may be repeated for the same or different counterparty communication system for subsequent communication sessions for which a dedicated network slice may be desired. In one example, steps 250 and 260 may be repeated on an ongoing basis to continue to monitor and report throughout the existence of the network slice. In one example, the method 200 may alternatively or additionally include the processing system requesting the network slice and receiving the NST, where the communication network may validate the request for the network slice, grant the NST when the request is valid, and commence establishment of the network slice. In other words, the slice instantiation request of optional step 220 is not necessary/may be omitted in such case. In one example, the method 200 may be expanded or modified to include steps, functions, and/or operations, or other features described above in connection with the example(s) of FIG. 1 and/or FIG. 3, or as described elsewhere herein. Thus, these and other modifications are all contemplated within the scope of the present disclosure.

FIG. 3 illustrates a flowchart of an example method 300 for detecting at least one anomaly from one or more performance indicators associated with data traffic communications via a network slice obtained from a first communication system participating in a communication session via the network slice in accordance with a network slicing token, in accordance with the present disclosure. In one example, steps, functions and/or operations of the method 300 may be performed by a device as illustrated in FIG. 1, e.g., a processing system comprising a slice orchestrator 193, NWDAF 192, SMO 190 and/or RIC 199, or the like, or collectively via a plurality devices in FIG. 1, such as slice orchestrator 193, NWDAF 192, SMO 190, RIC 199, or the like in conjunction with a different one of such components and/or any one or more other components in FIG. 1, such as UE 104 and/or 106, one or more of the server(s) 185, components of access network 120 (e.g., cell sites 121-124, BBU pool 126, etc.) and/or other components of the cellular core network 130 (e.g., NSSF 136, slice infrastructure, e.g., slice 160, AMF 135, SMF 137, UPF 139, etc.), and so forth. In one example, the steps, functions, or operations of method 300 may be performed by a computing device or system 400, and/or a processing system 402 as described in connection with FIG. 4 below. For instance, the computing device 400 may represent at least a portion of a slice orchestrator 193, NWDAF 192, SMO 190, RIC 199, etc. in accordance with the present disclosure. For illustrative purposes, the method 300 is described in greater detail below in connection with an example performed by a processing system, such as processing system 402. The method 300 begins in step 305 and may proceeds to optional step 310 or to step 360.

At optional step 310, the processing system, e.g., deployed in a communication network, may obtain a network slice instantiation request from a first communication system. For instance, the communication network may comprise a wireless network, e.g., a cellular network. In one example, at least one of the first communication system or a second communication system communicating via the network slice may comprise a cellular endpoint device, e.g., a user equipment.

At optional step 320, the processing system may detect that a number of network slicing token requests from the first communication system exceeds a threshold. For instance, the threshold may be set by a network operator in advance, may be based on an average number of requests from endpoint devices, e.g., of a same user category and/or type, from a same server category and/or type, from a same entity category and/or type (e.g., financial institutions, medical service providers, etc.), and so forth.

At optional step 330, the processing system may perform at least one remedial action in the communication network in response to the detecting. For instance, optional step 330 may include denying the network slice instantiation request, closing any dedicated/individualized slice(s) that is/are currently open for the first communication system, etc. Optional step 330 may also include transmitting an alert to the first communication system and/or to one or more other devices or accounts associated with a user/operator of the first communication system. For instance, this may include a warning that the first communication system may be misconfigured, may be compromised with malware that may be generating slice-based DoS attacks, or the like.

At optional step 340, the processing system may transmit, in response to the network slice instantiation request, a network slicing token (NST) to the first communication system. For instance, optional step 340 may further include verifying the request and/or authenticating the first communication system, etc. In one example, the NST may comprise a configuration code to cause the first communication system to perform a data traffic monitoring function. For instance, the data traffic monitoring function may include collecting the one or more performance indicators associated with data traffic communications via the network slice and transmitting the one or more performance indicators to the communication network.

At optional step 350, the processing system may establish the network slice in response to the network slice instantiation request. For instance, the processing system may select a network function resource allocation of an AMF, a SMF, and a UPF. In one example, the network slice may further comprise a network resource allocation of at least one RAN component, e.g., a CU, a DU, and/or a RU, etc. In one example, the network slice may further comprise a network resource allocation of one or more transport network components, e.g., intermediate devices between a RAN and cellular core network, or the like. In one example, optional step 350 may include transmitting one or more instructions and/or request(s) to another NF, such as a SMO to instantiate one or more NFs (e.g., VNFs), may include transmitting instructions to the one or more NFs to operate as an integrated slice, may include transmitting instructions to apply the requisite QoS/SLA guarantees to the data traffic over the network slice, and so forth.

At step 360, the processing system may obtain from the first communication system participating in a communication session with a second communication system via the network slice of the communication network, one or more performance indicators associated with data traffic communications via the network slice of the communication network. In one example, the one or more performance indicators may be obtained in accordance with the NST. For instance, the one or more performance indicators may be received with a hashed token identifier of the network slicing token (e.g., the first communication system may append it along with the reporting of the one or more performance indicators so that the processing system can properly attribute the one or more performance indicators to the correct network slice being monitored). In one example, the one or more performance indicators may include at least one of: a data traffic volume (e.g., inbound, outbound, and/or both individually or combined) or a data traffic pattern (e.g., packet rate, average packet size, packet inter-arrival time, average burst duration, average burst size, and so forth).

At optional step 370, the processing system may obtain, from the second communication system in accordance with the NST, one or more additional performance indicators associated with the data traffic communications via the network slice of the communication network. For instance, the NST may be configured to be replicated by the first communication system and forwarded to the second communication system, where the configuration code is to configure the second communication system to likewise perform the same or similar data traffic monitoring function.

At step 380, the processing system detects at least one anomaly from the one or more performance indicators associated with data traffic communications via the network slice. In one example, the detecting of the at least one anomaly may be further from the one or more additional performance indicators associated with the data traffic communications via the network slice (e.g., which may be collected from the second communication system at optional step 370). As described above, the at least one anomaly may comprise a denial of service (DoS) attack, a resource over-commitment of the network slice, and so forth. For instance, a network slice-based DoS attack can include spurious network traffic on the network slice or can include reserving the network slice and then not using it, which in some cases may still prevent the resources from being used by others. The at least one anomaly may alternatively or additionally include other malicious activities or other out-of-ordinary activities that can be problematic for the communication network, such as an application misconfiguration which may cause the first communication system to continuously send network slice establishment requests and/or NST requests. In one example, the detecting of the anomaly may be via at least one machine learning model that is implemented by the processing system. For instance, the machine learning model may be configured to output an indicator of whether an anomaly is exhibited in accordance with an input vector comprising the one or more performance indicators.

At step 390, the processing system performs at least one remedial action with respect to the network slice in response to the detecting of the anomaly from the one or more performance indicators. For instance, the at least one remedial action may comprise preventing the data traffic communications via the network slice (e.g., configuring/instructing NFs of the slice to block the data traffic, to not forward the data traffic (e.g., silent drop, etc.), or the like), de-instantiating the network slice, reconfiguring the network slice to include a different network function resource allocation (e.g., to use one or more different NFs), reconfiguring the network slice to include at least one additional network function resource allocation (e.g., to include a deep packet inspection (DPI) function, a scrubber, additional antivirus signature detection function(s), etc.), to have NFs of the network slice copy data traffic to another NF, such as a NWDAF, and so forth.

Following step 390, the method 300 proceeds to step 395 where the method 300 ends.

It should be noted that the method 300 may be expanded to include additional steps or may be modified to include additional operations with respect to the steps outlined above. For example, various steps of the method 300 may be repeated for the same or different communication system(s) for subsequent dedicated slice establishment requests. In one example, the method 300 may alternatively or additionally include collecting one or more training data sets from network slices of the first and/or the second communication system and/or from a plurality of different network slices for other communication systems (e.g., of a same device type, a same entity type, or the like), and then training one or more machine learning models as described above using the training data set(s). Alternatively, or in addition, the method 300 may further include determining one or more rule-based thresholds for anomaly detection, e.g., using the same or similar historic network performance data relating to various dedicated/individualized network slices. In one example, the method 300 may be expanded or modified to include steps, functions, and/or operations, or other features described above in connection with the example(s) of FIG. 1 and/or FIG. 2, or as described elsewhere herein. Thus, these and other modifications are all contemplated within the scope of the present disclosure.

In addition, although not specifically specified, one or more steps, functions, or operations of the example method 200 or the example method 300 may include a storing, displaying, and/or outputting step as required for a particular application. In other words, any data, records, fields, and/or intermediate results discussed in a respective method can be stored, displayed, and/or outputted either on the device executing the method or to another device, as required for a particular application. Furthermore, steps, blocks, functions or operations in FIGS. 2 and 3 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for commencing data traffic communications by a processing system with a counterparty communication system via a network slice of a communication network in accordance with a network slicing token that includes a configuration code to cause the processing system to perform a data traffic monitoring function and/or for detecting at least one anomaly from one or more performance indicators associated with data traffic communications via a network slice obtained from a first communication system participating in a communication session via the network slice in accordance with a network slicing token, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 406 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 405 for commencing data traffic communications by a processing system with a counterparty communication system via a network slice of a communication network in accordance with a network slicing token that includes a configuration code to cause the processing system to perform a data traffic monitoring function and/or for detecting at least one anomaly from one or more performance indicators associated with data traffic communications via a network slice obtained from a first communication system participating in a communication session via the network slice in accordance with a network slicing token (e.g., a software program comprising computer-executable instructions) can be loaded into memory 404 and executed by hardware processor element 402 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for commencing data traffic communications by a processing system with a counterparty communication system via a network slice of a communication network in accordance with a network slicing token that includes a configuration code to cause the processing system to perform a data traffic monitoring function and/or for detecting at least one anomaly from one or more performance indicators associated with data traffic communications via a network slice obtained from a first communication system participating in a communication session via the network slice in accordance with a network slicing token (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor from a communication network, a network slicing token, wherein the network slicing token comprises a configuration code to cause the processing system to perform a data traffic monitoring function, wherein the data traffic monitoring function comprises:
collecting one or more performance indicators associated with data traffic communications via a network slice; and
transmitting the one or more performance indicators to the communication network;
commencing, by the processing system, data traffic communications with a counterparty communication system via the network slice of the communication network in accordance with the network slicing token;
collecting, by the processing system, the one or more performance indicators associated with the data traffic communications via the network slice of the communication network in accordance with the configuration code; and
transmitting, by the processing system, to the communication network, the one or more performance indicators associated with the data traffic communications in accordance with the configuration code.

2. The method of claim 1, wherein the configuration code comprises an executable package.

3. The method of claim 1, where the configuration code comprises:
a virtual machine; or
a container.

4. The method of claim 1, further comprising:
transmitting a slice instantiation request to the communication network, wherein the slice instantiation request includes at least a fragment of the network slicing token.

5. The method of claim 4, wherein the network slice is established by the communication network in response to the slice instantiation request including the at least the fragment of the network slicing token.

6. The method of claim 1, further comprising:
transmitting, by the processing system to the counterparty communication system, a replica of the network slicing token.

7. The method of claim 6, wherein the replica of the network slicing token is to cause the counterparty communication system to perform the data traffic monitoring function.

8. The method of claim 6, wherein the replica of the network slicing token is transmitted to the counterparty communication system via the network slice.

9. The method of claim 1, wherein the commencing of the data traffic communications comprises:
transmitting one or more data packets to the counterparty communication system over the network slice.

10. The method of claim 9, wherein the commencing of the data traffic communications further comprises:
appending at least a fragment of the network slicing token to the one or more data packets transmitted to the counterparty computing system.

11. The method of claim 1, wherein the commencing of the data traffic communications comprises:
receiving one or more data packets from the counterparty communication system over the network slice.

12. The method of claim 1, wherein the one or more performance indicators comprise at least one of:
a data traffic volume; or
a data traffic pattern.

13. The method of claim 1, wherein the network slice comprises a network function resource allocation of:
an access management function;
a session management function; and
a user plane function.

14. An apparatus comprising:
a processing system including at least one processor; and
a computer-readable medium storing instructions which, when executed by the processing system, cause the processing system to perform operations, the operations comprising:
obtaining, from a communication network, a network slicing token, wherein the network slicing token comprises a configuration code to cause the processing system to perform a data traffic monitoring function, wherein the data traffic monitoring function comprises:
collecting one or more performance indicators associated with data traffic communications via a network slice; and
transmitting the one or more performance indicators to the communication network;
commencing data traffic communications with a counterparty communication system via the network slice of the communication network in accordance with the network slicing token;
collecting the one or more performance indicators associated with the data traffic communications via the network slice of the communication network in accordance with the configuration code; and
transmitting to the communication network, the one or more performance indicators associated with the data traffic communications in accordance with the configuration code.

15. A method comprising:
obtaining, by a processing system including at least one processor when deployed in a communication network from a first communication system participating in a communication session with a second communication system via a network slice of the communication network, one or more performance indicators associated with data traffic communications via the network slice of the communication network, wherein the one or more performance indicators are obtained in accordance with a network slicing token, wherein the network slicing token comprises a configuration code to cause the first communication system to perform a data traffic monitoring function, wherein the data traffic monitoring function comprises:
collecting the one or more performance indicators associated with data traffic communications via the network slice; and
transmitting the one or more performance indicators to the communication network;
detecting, by the processing system, at least one anomaly from the one or more performance indicators associated with data traffic communications via the network slice; and
performing, by the processing system, at least one remedial action with respect to the network slice in response to the detecting of the anomaly from the one or more performance indicators.

16. The method of claim 15, wherein the one or more performance indicators comprise at least one of:
a data traffic volume; or
a data traffic pattern.

17. The method of claim 15, wherein the at least one anomaly comprises at least one of:
a denial of service attack; or
a resource over-commitment of the network slice.

18. The method of claim 15, further comprising:
obtaining, from the second communication system in accordance with the network slicing token, one or more additional performance indicators associated with the data traffic communications via the network slice of the communication network, wherein the detecting of the at least one anomaly is further from the one or more additional performance indicators associated with the data traffic communications via the network slice.

19. The method of claim 15, wherein the detecting of the anomaly is via at least one machine learning model that is implemented by the processing system, wherein the machine learning model is configured to output an indicator of whether an anomaly is exhibited in accordance with an input vector comprising the one or more performance indicators.

20. The method of claim 15, wherein the at least one remedial action comprises at least one of:
preventing the data traffic communications via the network slice;
de-instantiating the network slice;
reconfiguring the network slice to include a different network function resource allocation;
reconfiguring the network slice to include at least one additional network function resource allocation; or
reconfiguring the network slice to copy the data traffic communications via the network slice to an additional network function.
